(19) United States
(12) Patent Application Publication
(10) Pub. No.: US 2013/0142532 A1
(43) Pub. Date: Jun. 6, 2013

(54) IMAGE FORMING APPARATUS

(71) Applicants: Oki Kitagawa, Kashiwa-shi (JP); Shigeaki Takada, Abiko-shi (JP); Akiyoshi Shinagawa, Kashiwa-shi (JP); Hiroki Kawai, Toride-shi (JP)

(72) Inventors: Oki Kitagawa, Kashiwa-shi (JP); Shigeaki Takada, Abiko-shi (JP); Akiyoshi Shinagawa, Kashiwa-shi (JP); Hiroki Kawai, Toride-shi (JP)

(73) Assignee: CANON KABUSHIKI KAISHA, Tokyo (JP)

(21) Appl. No.: 13/602,944

(22) Filed: Sep. 4, 2012

(30) Foreign Application Priority Data
Dec. 1, 2011 (JP) 2011-264057

(51) Int. Cl. G03G 15/20

(52) U.S. Cl. 399/67; 399/70; 399/122; 399/328

(57) ABSTRACT

An image forming apparatus is configured to be able to switch a target temperature of an image heating member from a standby target temperature during a standby state in which a pressurizing member is separated from the image heating member to a first target temperature or a second target temperature which is lower than the standby and first target temperatures. The image forming apparatus controls a contacting/separating mechanism such that a time from when an image forming signal is input until when the pressurizing member in the standby state contacts the image heating member and forms a nip is shorter in a case when the target temperature of the image heating member is the second target temperature than in a case when the target temperature of the image heating member is the first target temperature.

### BACKGROUND OF THE INVENTION

1. Field of the Invention

The present invention relates to an image forming apparatus including an image heating member configured to heat an image formed on a recording medium.

2. Description of the Related Art

Hitherto, there is widely used an image forming apparatus configured to transfer a toner image formed on an image carrier, i.e., an intermediate transfer member or a photosensitive member, on a recording medium and to fix the image on the recording medium by heating and pressurizing the recording medium by a heating nip composed of an image heating member and a pressurizing member. Then, lately, the image forming apparatus is required to accommodate to various types of recording media such as a thick sheet, a thin sheet and a coated sheet, in addition to a conventional plain sheet, and it is required to be able to set different heating target temperatures corresponding to the types of the recording media for the image heating member that contacts an image surface in a fixing apparatus.

Due to that, the image heating member of the fixing apparatus that is adapted to change the heating target temperature corresponding to the type of the recording medium is configured to stand by in a condition of being heated up to a target temperature of a standby state adjusted for the plain sheet that is frequently used. When it is commanded here to form an image on a thin sheet, a temperature adjusting circuit switches the target temperature for the plain sheet to a target temperature for a thin sheet, which is lower than the target temperature for the plain sheet. Then, the image forming apparatus starts to form the image after when the temperature of the image heating member measured by a temperature sensor is lowered and stabilized to the target temperature for a thin sheet.

In this case, however, it is unable to form the image until when the temperature of the image heating member converges to the target temperature for a thin sheet, so that the image forming apparatus requires a downtime which drops a productivity of the image forming apparatus. The image heating member is configured to have a large thermal capacity to reduce temperature fluctuation during passage of a recording medium in a highly productive image forming apparatus in particular, so that there is a case when such apparatus requires a cooling downtime of 10 seconds or more to lower the temperature just around 10° C.

In order for that, Japanese Patent Application No. 2000-181274 discloses a fixing apparatus provided with a blower fan to cool a fusing roller by air. Still further, Japanese Patent Application No. 2010-139817 discloses a fixing apparatus provided with a contactable cooling roller to remove heat from a fixing belt by contacting the cooling roller.

However, the fixing apparatus is enlarged if the fixing apparatus is provided with the blower fan or the contactable cooling roller as described above, in contrary to downsizing of the image forming apparatus. Still further, an increase of a number of parts and additional assembly costs pose a problem because they often turn out be an excessive investment for a thin sheet which is less used. Furthermore, even when the fixing apparatus is provided with the blower fan or the cooling roller as described above, it is required to be able to converge the temperature of the image heating member more efficiently to the second target temperature because the cooling downtime is desirable to be as short as possible.

### SUMMARY OF THE INVENTION

The present invention provides an image forming apparatus that is capable of reducing a waiting time in forming an image by quickly lowering temperature of an image heating member. According to an aspect of the present invention, an image forming apparatus includes an image heating member configured to heat an image formed on a recording medium, a heater configured to heat the image heating member, a pressurizing member configured to pressurize the image heating member to form a nip for nipping and conveying the recording medium, a contacting/separating mechanism configured to contact the pressurizing member with the image heating member and to separate the pressurizing member from the image heating member, and a control unit configured to control the heater such that a temperature of the image heating member is set at a target temperature and being able to switch, on starting to heat the image formed on the recording medium, the target temperature at least from a standby target temperature which is the target temperature during a standby state in which the pressurizing member is separated from the image heating member to a first target temperature which is the target temperature in heating an image formed on a first recording medium or to a second target temperature which is the target temperature in heating an image formed on a second recording medium whose basis weight is smaller than a basis weight of the first recording medium and which is lower than the standby target temperature and the first target temperature, the control unit controlling the contacting/separating mechanism such that a time from when an image forming signal is input until when the pressurizing member in the standby state contacts the image heating member and forms the nip is shorter in a case when the target temperature of the image heating member is the second target temperature than in a case when the target temperature of the image heating member is the first target temperature.

Further features of the present invention will become apparent from the following description of exemplary embodiments with reference to the attached drawings. The accompanying drawings, which are incorporated in and constitute a part of the specification, illustrate exemplary embodiments, features, and aspects of the invention and, together with the description, serve to explain the principles of the invention.

### BRIEF DESCRIPTION OF THE DRAWINGS

FIG. 1 is a diagram explaining a configuration of an image forming apparatus according to a first embodiment.

FIG. 2 is a block diagram of a control system of the image forming apparatus of the first embodiment.

FIG. 3 is a diagram explaining a configuration of the fixing apparatus of the first embodiment in section vertical to axes thereof.

FIG. 4 is a fixation control flowchart of the fixing apparatus of the first embodiment;

FIG. 5 is a time chart of the fixation control implemented on a plain sheet.

FIG. 6 is a time chart of the fixation control implemented on a thin sheet.

FIG. 7 is a time chart of the fixation control implemented on a thick sheet.

FIG. 8 is a fixation control flowchart of the fixing apparatus according to a second embodiment.

FIG. 9 is a fixation control flowchart of the fixing apparatus according to a third embodiment.

FIG. 10 is a time chart of the fixation control implemented on a thin sheet according to the third embodiment.

FIG. 11 is a time chart illustrating effects of the control of the third embodiment.

FIG. 12 is a fixation control flowchart of the fixing apparatus according to a fourth embodiment.

### DESCRIPTION OF THE EMBODIMENTS

Embodiments of the present invention will be explained below with reference to the drawings.

### First Embodiment

### <Image Forming Apparatus>

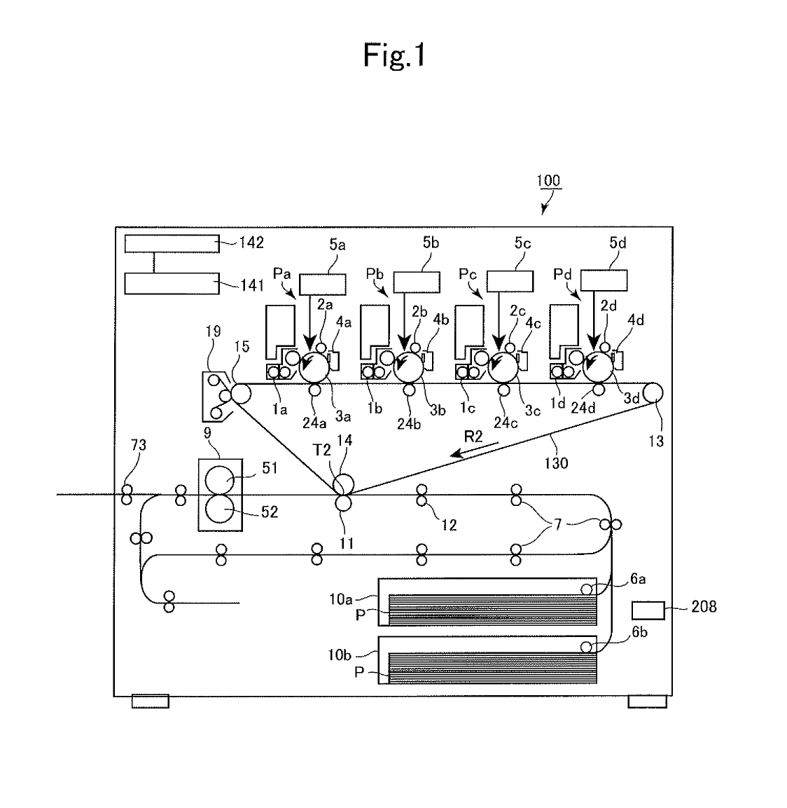

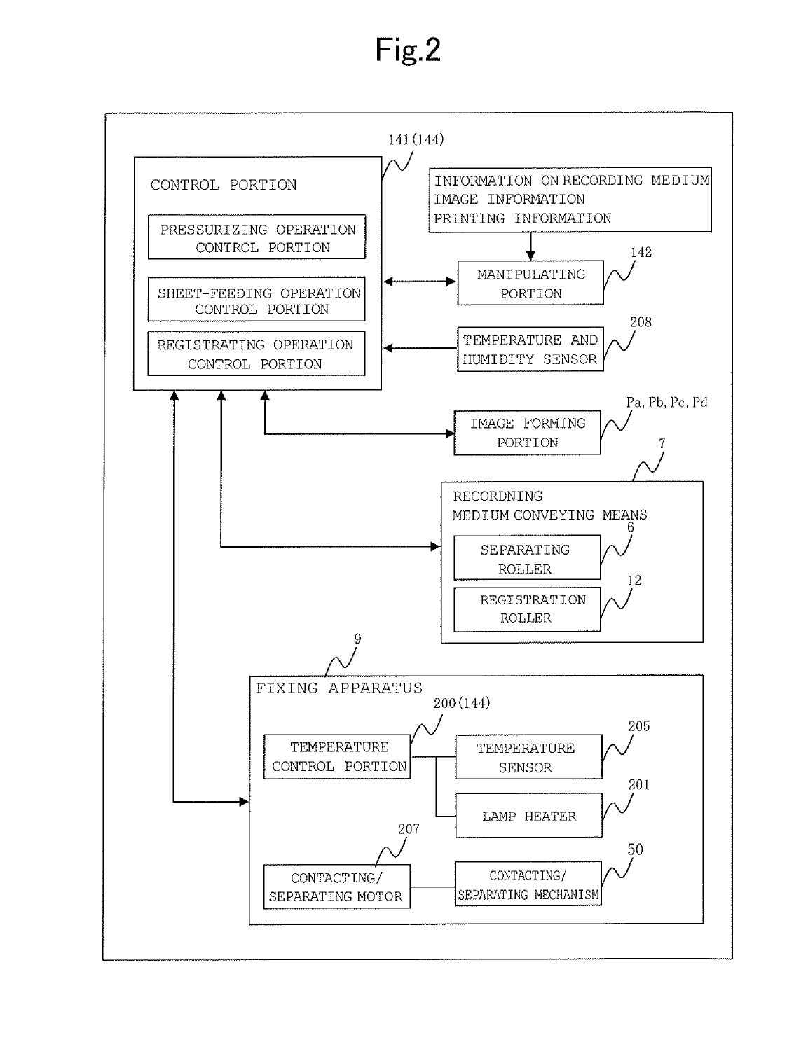

FIG. 1 is a diagram explaining a configuration of an image forming apparatus 100 of a first embodiment of the invention, and FIG. 2 is a block diagram of a control system of the image forming apparatus 100.

As shown in FIG. 1, the image forming apparatus 100 is a tandem intermediate transfer-type full-color printer in which yellow, magenta, cyan and black image forming portions Pa, Pb, Pc and Pd are arrayed along an intermediate transfer belt 130.

A yellow toner image is formed on a photosensitive drum 3a and is transferred to the transfer belt 130 in the image forming portion Pa. In the same manner, a magenta toner image, a cyan toner image, and a black toner image are formed on photosensitive drums 3b, 3c and 3d and are transferred to the transfer belt 130 in the image forming portions Pb, Pc and Pd, respectively.

The four color toner images carried on the transfer belt 130 are conveyed to a secondary transfer portion T2 and are secondarily transferred to a recording medium P collectively. The recording medium P is pulled out of a recording medium cassette 10a by a pickup roller, is separated one by one by a separation roller 6a and is fed to a registration roller 12. The registration roller 12 sends the recording medium P to the secondary transfer portion T2 by adjusting timing with the toner images on the transfer belt 130.

The recording medium P on which the four color toner images are secondarily transferred self-strips and is sent to a fixing apparatus 9. The fixing apparatus 9 heats up and pressurizes the recording medium P carrying the toner images to fix the toner images on the surface of the recording medium P. Then, the recording medium P is discharged out of the apparatus.

The image forming apparatus 100 can print successively by repeating the operations of feed, registration, image-forming (secondary transfer), fixation and discharge described above. The apparatus 100 can print 80 sheets per minute for example by transversely feeding A4-size sheets.

The image forming apparatus 100 is provided with a control portion 141 as shown in FIG. 1. The control portion 141 manages overall operations of the image forming apparatus 100 to form images by controlling command systems among the respective units while monitoring and controlling operations of the respective units as shown in FIG. 2.

The image forming apparatus 100 is also provided with a manipulating portion 142 as an interface for a user to access the apparatus 100. The manipulating portion 142 allows the user to set basic print job information such as recording medium information such as basis weight, image information such as density, and a number of recording media to be printed.

The image forming apparatus 100 of the present embodiment is configured to be able to execute a so-called “consolidated job” of printing images by consecutively switching types of recording media. The recording medium cassettes 10a and 10b are configured to feed plain sheets, thin sheets and thick sheets as the recording media to a heating nip N provided in the fixing apparatus 9. The “consolidated job” permits to print brochures for example each composed of a thick cover sheet, documents printed on thin sheets and pictures printed on coated sheets one by one. A user is allowed to set details of the consolidated job such as setting of temperature of the fixing apparatus 9 per type of the recording medium through the manipulating portion 142.

### <Image Forming Portion>

As shown in FIG. 1, the image forming portions Pa, Pb, Pc and Pd are configured to be substantially identical except the colors of the toners used in their respective developers 1a, 1b, 1c and 1d. Therefore, the image forming portions Pa, Pb, Pc and Pd will be described as the image forming portion P in general hereinafter by excluding a, b, c and d appended at ends of the reference numerals denoted to the respective components.

The image forming portion P is provided with a charging roller 2, an exposure unit 5, the developer 1, a transfer roller 24 and a drum cleaner 4 disposed so as to surround a photosensitive drum 3. The photosensitive drum 3 has an optical semiconductor photosensitive layer formed around an outer circumferential surface of an aluminum cylinder and rotates in a direction of an arrow shown in FIG. 1 with predetermined processing speed.

The charging roller 2 charges the photosensitive drum 3 with homogeneous negative dark potential VD. The exposure unit 5 scans the photosensitive drum 3 by an ON/OFF modulated laser beam according to scan-line image data in which a decomposed color image of each color is developed to draw an electrostatic image on a surface of the charged photosensitive drum 3. The developer 1 supplies toner to the photosensitive drum 3 to develop the electrostatic image as a toner image.

The transfer roller 24 presses the transfer belt 130 to form a transferring portion between the photosensitive drum 3 and the transfer belt 130. The toner image carried on the photosensitive drum 3 is transferred to the transfer belt 130 by applying DC voltage to the transfer roller 24. The drum cleaner 4 recovers the remaining transfer toner attached to the surface of the photosensitive drum 3 that has passed the transferring portion by slidingly contacting a cleaning blade to the photosensitive drum 3.

### <Secondary Transfer Portion>

As shown in FIG. 1, the transfer belt 130 is wrapped around and supported by a tension roller 15, a counter roller 14, and a driving roller 13, and rotates in a direction of an arrow R2 by being driven by the driving roller 13. The secondary transfer portion T2 is configured by the transfer belt 130 supported by the counter roller 14 and a secondary transfer roller 11 in contact with the transfer belt 130. The toner image carried on the transfer belt 130 is transferred secondarily to the recording medium P conveyed to the secondary transfer portion T2 by DC voltage applied to the secondary transfer roller 11. The belt cleaning unit 19 removes the toner and paper dust by contacting a cleaning web (unwoven cloth) to a surface of the transfer belt 130.

The control portion 141 executes a secondary transfer roller cleaning control operation between images (between sheets) in consecutively forming the images and after finishing the image forming job. The secondary transfer roller cleaning control operation is performed to prevent degradation of the transfer performance of the secondary transfer roller 11 and a stain of a back side of the recording medium by recovering scattered toner and fogging toner attached to the secondary transfer roller 11 by applying DC voltage having the same polarity with the toner charge for a predetermined period of time.

### <Registration Rollers>

FIG. 1 shows registration rollers 12 composed of a rubber roller made of ethylene propylene rubber with φ16 mm in diameter and disposed on a back side of the recording medium and a metallic roller made of SUS (stainless steel) with φ16 mm in diameter and disposed on a front side of the recording medium to pressurize with 1 kg of load. ASKER-C hardness of the rubber roller is 40° (1 kg load) and surface roughness Rz is about 20 μm.

The registration rollers 12 prevent the recording medium from advancing obliquely by temporarily stopping the recording medium P by a conveying nip formed by the rubber rand metallic rollers described above. Then, the rollers 12 feed the recording medium P by adjusting timing for forming the image with timing for feeding the recording medium P, such that position of an image to be formed on the recording medium P is adequately adjusted. The control portion 141 controls the conveyance and stoppage of the recording medium P in feeding the recording medium P to the secondary transfer portion T2 by rotating the rubber roller by actuating a stepping motor not shown.

### <Fixing Unit>

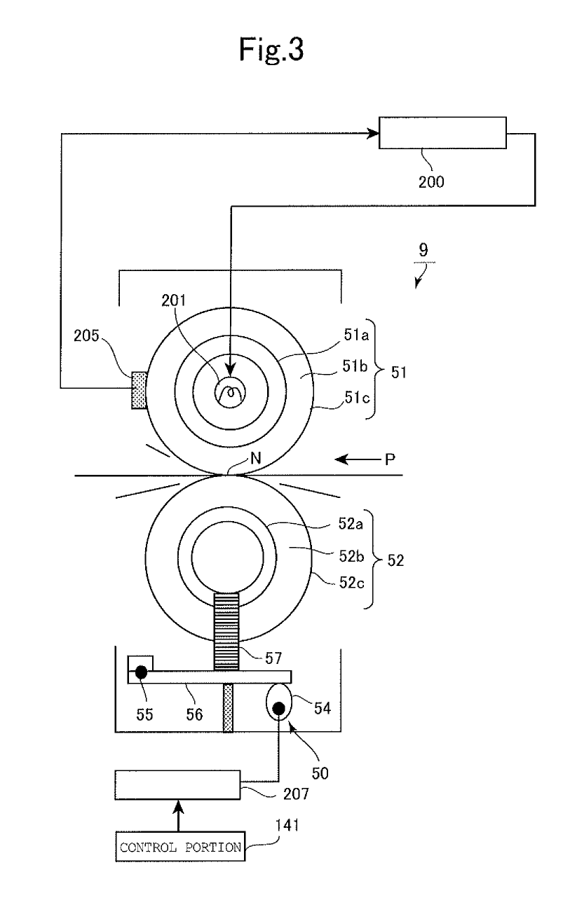

FIG. 3 is a diagram explaining a configuration of the fixing apparatus in section vertical to axes of rollers described below. As shown in FIG. 3, the recording medium P passes through the fixing apparatus 9 from right to left in FIG. 3 and is heated and pressed in a process of being conveyed by the heating nip N composed of a fusing roller (image heating member) 51 disposed on an image surface side and a pressure roller (pressurizing member) 52 disposed on a non-image surface side such that the toner image is fixed on the surface of the recording medium P.

The fixing apparatus 9, i.e., one exemplary image heating apparatus, controls temperature of the fusing roller 51 to a plurality of target temperatures that correspond to types of recording media whose basis weight and surface nature are different. The target temperature is set such that both conveyance (wrinkles and separability) and imaging property (fixability, toner offset) are achieved for a non-coated sheet whose surface is paper texture and such that the heavier the basis weight of the recording medium, the higher the target temperature is. However, the target temperature is set by considering glossiness of images, in addition to the conveyance and imaging property, for a coated sheet in which a resin layer is formed on a surface thereof. The target temperature is set such that the heavier the basis weight, the higher the target temperature is for a gloss coated sheet in which a glossy coating layer is formed. However, the target temperature is set low within a fixing permissible range for a matt coated sheet having a coating layer whose glossiness is suppressed.

The fixing apparatus 9 forms the heating nip N by press-contacting the fusing roller 51, whose temperature is controlled to be more than a fusion point of the toner, and the pressure roller 52 with each other to nip and convey the recording medium carrying the toner image.

The fusing roller 51 is formed by wrapping an elastic layer 51b of silicon rubber with 4 mm thick around an outer circumference of a core metal 51a, i.e., a mild steel cylindrical material, having an outer diameter of φ72 mm. Then, a surface of the elastic layer 51b is coated by a releasing layer 51c, i.e., a PFA (tetrafluoroetylene-perfluoroalkyl vinylether copolymer) tube, of 30 μm thick.

The pressure roller 52 is formed by wrapping an elastic layer 52b of silicon rubber with 2 mm thick around an outer circumference of a core metal 52a, i.e., a mild steel cylindrical material, having an outer diameter of φ76 mm. Then, a surface of the elastic layer 52b is coated by a releasing layer 52c, i.e., a PFA tube, of 30 μm thick.

A lamp heater (halogen heater) 201 of 900 W, i.e., one exemplary heater, configured to heat the image heating member is disposed within the fusing roller 51. A temperature sensor (thermistor) 205 is disposed in contact with the surface of the fusing roller 51 on an exit side of the heating nip N at a center in a rotational axial direction of the roller.

A temperature control portion 200 adjusts surface temperature of the fusing roller 51 detected by the temperature sensor 205 to the target temperature per each recording medium P by controlling power supplied to the lamp heater 201 based on an output of the temperature sensor 205.

TABLE 1

| | TARGET | STANDBY |
|---|---|---|
| TYPE OF RECORDING | TEMPERATURE OF | TEMPERATURE OF |
| MEDIUM | FUSING ROLLER | FUSING ROLLER |
| THIN SHEET | 160° C. | 180° C. |
| PLAIN SHEET | 180° C. | |
| FIRST THICK SHEET | 190° C. | |
| SECOND THICK | 200° C. | |
| SHEET | | |

As shown in Table 1, the target temperature is kept low to prevent entangled jamming by assuring separability from the fusing roller 51 for a thin sheet (52 to 63 g/m²), and the target temperature is set at 160° C. The target temperature for a plain sheet (64 to 105 g/m²) is set at 180° C.

Because a thermal load of the fusing roller 51 is large for a thick sheet, the target temperature is set high in order to assure fixability of the toner image. That is, the target temperature of the first thick sheet (106 to 150 g/m²) is set at 190° C. and the target temperature of the second thick sheet (150 to 220 g/m²) is set at 200° C.

A standby temperature of the fusing roller 51 set during a standby period, which enables to start to print immediately, is set at 180° C. as an initial setting such that no waiting time is required in printing on a plain sheet frequently used. However, the setting of the standby temperature can be changed to 190° C. or 200° C. through the manipulating portion 142 if the user frequently uses thick sheets.

That is, control unit 144 of the image forming apparatus 100 includes the control portion 141 and the temperature control portion 200. The control portion 141 sets the target temperature and the temperature control portion 200 controls the heater 201 based on the target temperature. Thus, the control unit 144 can control the temperature of the fusing roller 51, i.e., the image heating member, such that the temperature of the fusing roller 51 is set at the target temperature by controlling the heater (lamp heater) 201. Still further, in heating an image formed on a recording medium, the control portion 141 can switch the target temperature at least from the standby target temperature which is the target temperature during the standby state in which the fusing roller 51 is separated from the pressure roller 52 to a first target temperature which is the target temperature in heating an image formed on a first recording medium such as a thick sheet for example or to a second target temperature which is target temperature in heating an image formed on a second recording medium such as a thin sheet whose basis weight is smaller than that of the first recording medium and which is lower than the standby target temperature and the first target temperature.

It is noted that the both image heating and pressurizing members forming the heating nip N of the fixing apparatus 9 adopt the rollers in the present embodiment. However, at least one of the image heating and pressurizing members may be configured by a seamless belt. A fixing apparatus whose image heating member is configured by the seamless belt and which is provided with a contacting/separating mechanism to arrange the heating nip to be releasable is also often used. Still further, although the first recording medium is assumed to be a thick sheet in the present embodiment, the plain sheet may be a first recording medium when a thin sheet is adopted as the second recording medium. The thick sheet may be also the first recording medium when the plain sheet is the second recording medium.

### <Contacting/separating Mechanism>

As shown in FIG. 3, the fixing apparatus 9 of the present embodiment is provided with a contacting/separating mechanism 50 that allows the pressure roller 52 to pressurize and separate from the fusing roller 51 in order to save energy and to deal with many types of recording media. The fixing apparatus 9 stands by for the image forming job in the state in which the pressure roller 52 is separated from the fusing roller 51 and the temperature of the fusing roller 51 is controlled at the target temperature of the standby state.

It is possible to contact or separate the pressure roller 52 with/from the fusing roller 51 by actuating the contacting/separating mechanism 50. Both end portions of the core metal 51a of the fusing roller 51 are supported rotatably by bearings whose level is fixed. In contrary to that, both end portions of the core metal 52a of the pressure roller 52 are supported by a pressurizing frame 56 turnable centering on a turning axis 55 through an intermediary of a pressurizing spring 57, so that the pressure roller 52 can be moved up and down.

When a contacting/separating motor 207 rotates a pressurizing cam 54 to move up a turning end of the pressurizing frame 56, the pressure roller 52 abuts the fusing roller 51 due to a pressurizing force of the pressurizing spring 57. In contrary, when the contacting/separating motor 207 rotates the pressurizing cam 54 to drop the turning end of the pressurizing frame 56, the pressure roller 52 separates from the fusing roller 51.

The control portion 141 controls the contacting/separating motor 207 to pressurize and release the pressure roller 52 and can switch the state of pressurizing the fusing roller 51 with the state separated from the fusing roller 51 within a required time of 0.8 second for example in the present embodiment. A total load of the pressure roller 52 caused by the contacting/separating mechanism 50 during the press-contact is about 60 kgf, so that the heating nip N having a length of about 10 mm is formed in a sheet conveying direction. When the pressure roller 52 is separated, a distance from the surface of the fusing roller 51 to the surface of the pressure roller 52 is about 2 mm in the present embodiment.

A first object of the contacting/separating mechanism 50 is to reduce a thermal load required in heating the fusing roller 51 up to the standby temperature in activating the fixing apparatus by separating the pressure roller 52 and thus to shorten a warm-up time. The separation of the pressure roller 52 from the fusing roller 51 permits to prevent the heat of the fusing roller 51 from being deprived, to shorten the warm-up time and to considerably reduce power consumption of the fixing apparatus 9.

A second object of the contacting/separating mechanism 50 is to improve user's capability of handling a jammed recording medium P by enabling to separate the pressure roller 52 when the jam occurs.

A third object of the contacting/separating mechanism 50 is to deal with a special recording medium by suppressing an increase of temperature of the pressure roller 52 by reducing a time in contact with the fusing roller 51. It is possible to reduce heat transferred to the recording medium P passing through the heating nip N and to suppress vapor from being generated within the tissue of the recording medium P by preventing the increase of the temperature of the pressure roller 52 by separating the pressure roller 52 during when no image is formed.

However, if a wet and low basis weight coated sheet is heated excessively, a large amount of vapor is generated within the tissue of the recording medium P. The vapor whose move to a sheet surface is hampered by a coated layer escapes out of a sheet back surface, possibly making the pressure roller 52 to slip the conveyance. There is also a possibility of causing such a phenomenon, i.e., a so-called blister phenomenon, that the inner vapor that cannot escape to the back surface breaks through the surface coated layer and disturbs an image.

### <Cooling Waiting Time of Fusing Roller>

When the fixing apparatus 9 that has the plurality of target temperatures per type of the recording media switches the target temperatures, it takes a longer waiting time in temperature control operations in a case when the temperature is lowered than a case when the temperature is increased. It is possible to readily shorten a temperature increase time if a large power or IH heating (inductive electromagnetic heating) is used. However, it is necessary to rapidly radiate thermal energy accumulated in the fusing roller 51 in order to lower the temperature because the highly-productive fixing apparatus 9 adopts the fusing roller 51 whose thermal capacity is large to suppress temperature fluctuation of the heating nip N in successively forming images. When the recording media P are switched frequently from thick sheets to thin sheets in the consolidated job in particular, the waiting time for the temperature control occurs frequently and prominently, thus influencing the total productivity of the image forming apparatus 100.

Then, in order to solve such problem, there is proposed to dispose an air blower at an outer peripheral part of the fusing roller 51 to lower the temperature to the target temperature by blowing air to the fusing roller 51.

However, the air blower is required to be large to cool down the fusing roller 51 to the desired target temperature in a short time and the fusing roller 51 itself is enlarged to assure an air blowing space.

Then, the fixing apparatus 9 having the contacting/separating mechanism 50 of the present embodiment is configured to control the temperature of the fusing roller 51 to be an appropriate temperature uniformly and stably within a short time by making use of roller separating and sheet conveyance sequences corresponding to the types of the recording media P. Still further, the fixing apparatus 9 is configured to control the temperature of the fusing roller 51 appropriately corresponding to the types of recording media by controlling the nip pressurizing timing in starting to form an image.

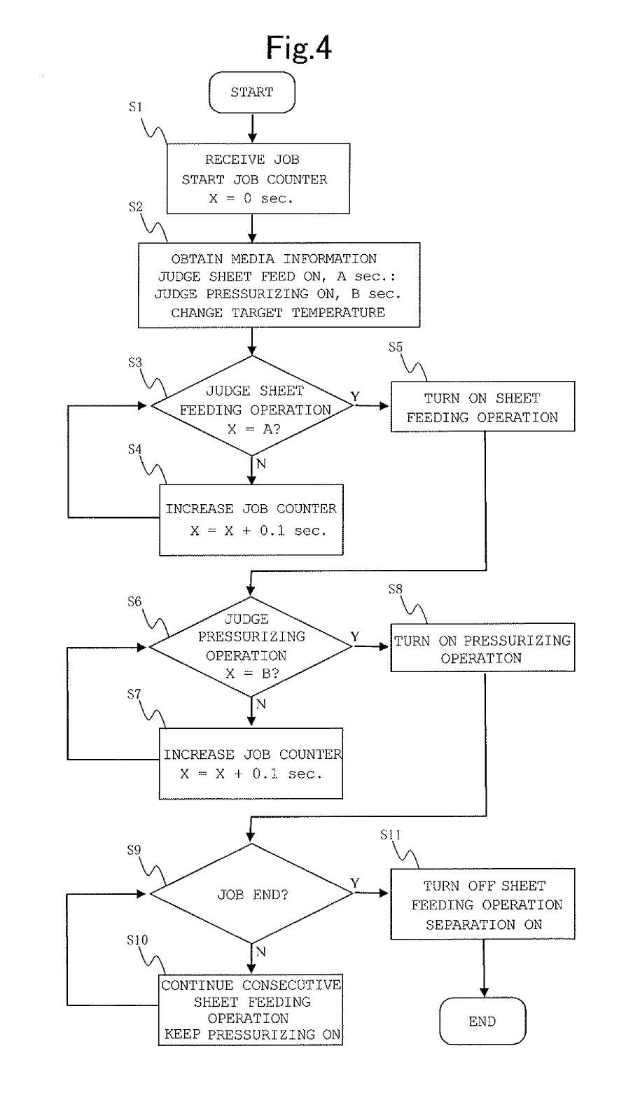

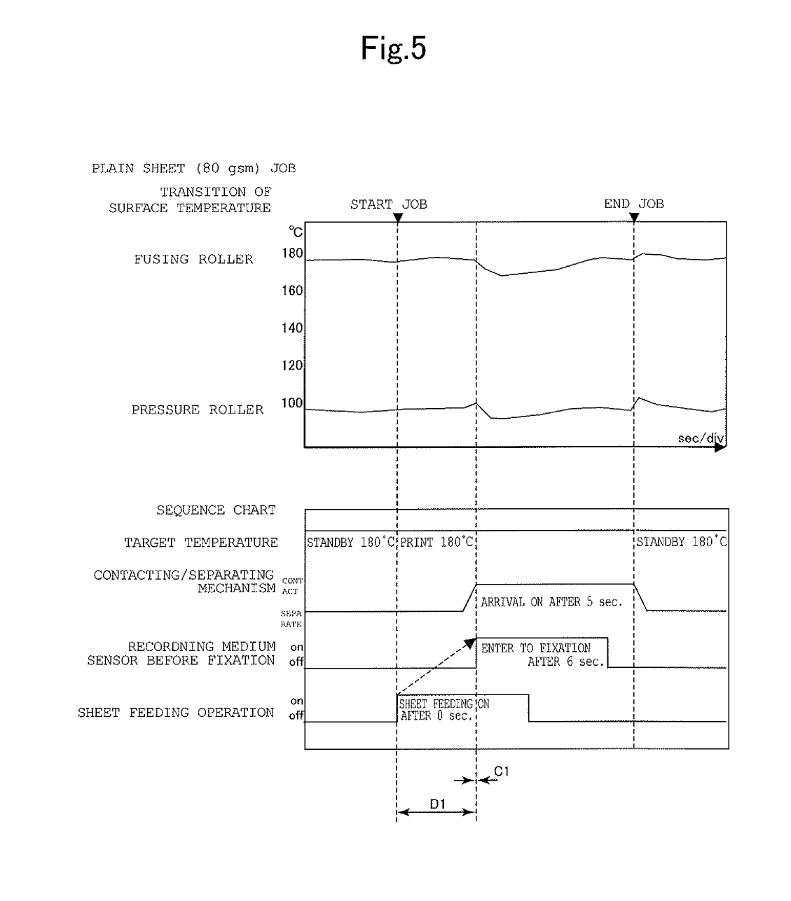

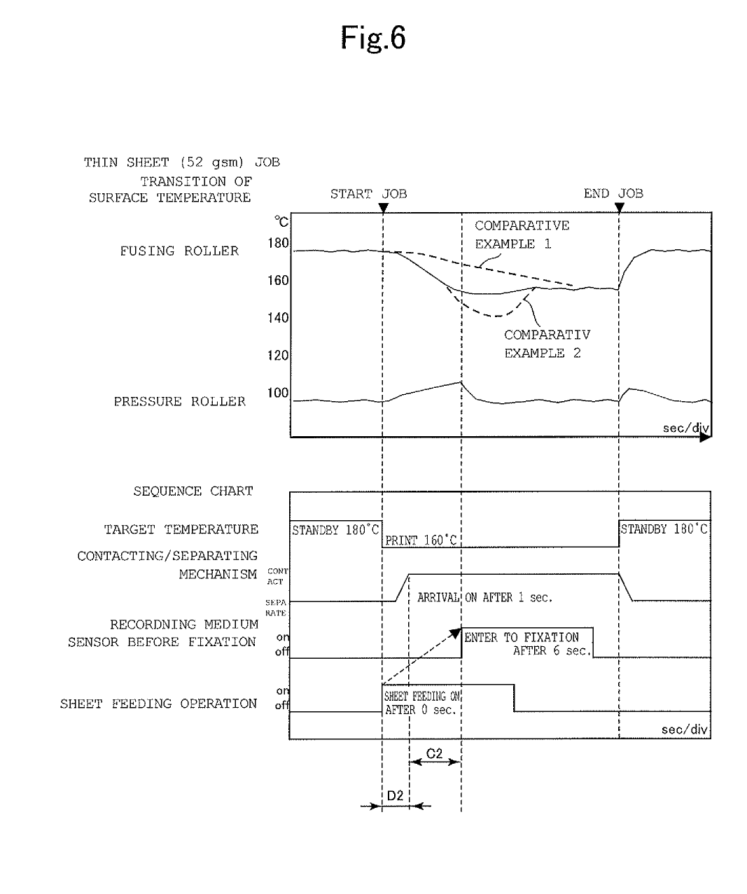

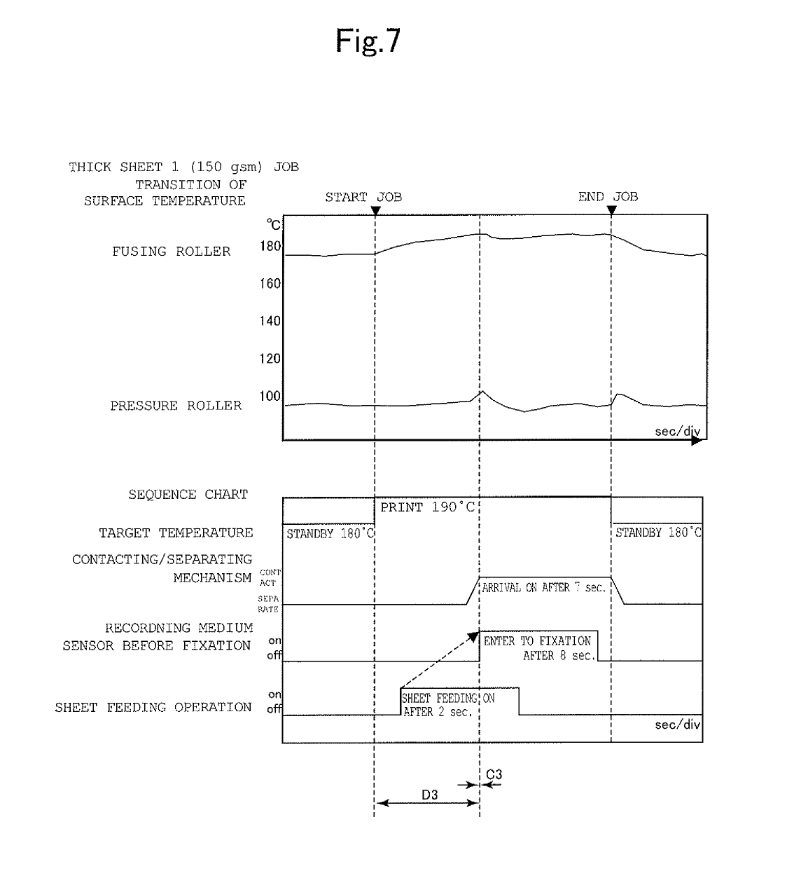

FIG. 4 is a fixation control flowchart of the fixing apparatus of the first embodiment, FIG. 5 is a time chart of the fixation control implemented on a plain sheet, FIG. 6 is a time chart of the fixation control implemented on a thin sheet, and FIG. 7 is a time chart of the fixation control implemented on a thin sheet. Here, the unit of the basis weight g/m² will be denoted as gsm.

As shown in FIG. 1, the fusing roller 51, i.e., one exemplary image heating member, heats up the image formed on the recording medium. The pressure roller 52, i.e., one exemplary pressurizing member, pressurizes the fusing roller 51 and forms the nip for nipping and conveying the recording medium. The contacting/separating mechanism 50, i.e., one exemplary contacting/separating mechanism, contacts and separates the pressure roller 52 with/from the fusing roller 51. The temperature sensor 205, i.e., one exemplary temperature detecting member, detects temperature of the fusing roller 51. The temperature control portion 200, i.e., one exemplary power control means, controls power of the lamp heater 201 such that the temperature of the fusing roller 51 turns out to be a target temperature set in advance.

With reference to FIG. 2 and as shown in FIG. 3 in particular, the manipulating portion 142 and the control portion 141 discriminate, as one exemplary discriminating means, the types of the recording media based on inputs of the user. The control portion 141 discriminates the types of the recording media based on data of a received image forming job. The control portion 141 permits to execute, as one exemplary executing portion, at least processes of forming an image on a thick sheet, i.e., one example of a first mode, and of forming an image on a thin sheet, i.e., one example of a second mode.

In the process of forming the image on the thick sheet, the temperature control portion 200 controls the power such that the target temperature of the fusing roller 51 reaches 190° C., i.e., one example of the first target temperature, to heat up the image formed on the thick sheet, i.e., one example of a first recording medium. In the process of forming the image on the thin sheet, the temperature control portion 200 controls the power such that the target temperature of the fusing roller 51 reaches 160° C., i.e., one example of the second target temperature which is lower than 190° C., to heat up the image formed on the thin sheet, i.e., one example of a first recording medium whose basis weight is smaller than the basis weight of the thick sheet.

The control portion 141 executes, as one exemplary standby mode executing portion, processes in a standby state of the image forming job, i.e., one exemplary standby mode. In the standby state of the image forming job, the temperature control portion 200 controls power such that the temperature of the fusing roller 51 is set at 180° C., i.e., one example of the standby target temperature, which is higher than 160° C., i.e., the second target temperature, in the state in which the pressure roller 52 is separated from the fusing roller 51, to stand by for an input of an image forming signal. When the image forming signal is input, the control portion 141 switches the target temperature and controls the contacting/separating mechanism 50 to start the operation for contacting the pressure roller 52 with the fusing roller 51.

The control portion 141 controls the temperature of the surface of the fusing roller 51 when the recording medium P enters the heating nip N by executing the pressurizing operation of the heating nip N of the fixing apparatus 9 by a delay time set in advance per type of the recording medium from the sheet feeding operation of the separation roller 6 in the first embodiment. Table 2 shows the sheet feeding ON timing and pressurizing ON timing per type of the recording medium of the first embodiment.

TABLE 2

| TYPE OF | SHEET FEEDING | PRESSURIZING | HEATING NIP |
|---|---|---|---|
| RECORDING | OPERATION: | OPERATION: | ENTERING |
| MEDIUM | ON [A] | ON [B] | TIMING |
| THIN SHEET | 0 sec. | 1 sec. | (6 sec.) |
| PLAIN SHEET | 0 sec. | 5 sec. | (6 sec.) |
| FIRST | 2 sec. | 7 sec. | (8 sec.) |
| THICK | | | |
| SHEET | | | |
| SECOND | 4 sec. | 9 sec. | (10 sec.) |
| THICK | | | |
| SHEET | | | |

As shown in Table 2, the control portion 141 controls the contacting/separating mechanism 50 and the recording medium cassettes 10a and 10b based on the feeding timing of the recording media set in advance per type of the recording medium and the heating nip N forming timing. The sheet feeding ON timing and pressurizing ON timing per type of the recording medium are set in advance as fixed values (second) in the control portion 141. The control portion 141 obtains the necessary sheet feeding ON timing and the pressurizing ON timing by making reference to the types of the recording media in Table 2. The control portion 141 operates an internal timer when it accepts an image forming job, executes the sheet feeding operation when the sheet feeding ON timing set in Table 2 elapses since then, and executes the pressurizing operation when the pressurizing ON timing elapses.

In a case of starting to heat a thin sheet from the standby state of the image forming job, the control portion 141 prolongs a time from when the heating nip N is formed until when the recording medium reaches the heating nip N more than that in a case of heating a plain sheet from the standby state of the image forming job (C1<C2, see FIGS. 5 and 6).

In a case of starting to heat a thick sheet from the standby state of the image forming job, the control portion 141 equalizes a time from when the heating nip N is formed until when the recording medium reaches the heating nip N with that of the case of heating the plain sheet from the standby state of the image forming job (C1=C3, see FIGS. 5 and 7).

With reference to FIG. 2 and as shown in FIG. 4 in particular, the control portion 141 resets a JOB counter X and starts a timer operation by receiving JOB information in Step 1.

The control portion 141 reads information related to the type of the recording medium P contained in the JOB information and obtains a target temperature, sheet feeding timing A (second) and pressurizing timing B (second) of the heating nip N to be adopted by making reference to Table 2 with the type of the recording medium in Step 2. Then, the control portion 141 instructs the temperature control portion 200 to switch the target temperature of the fusing roller 51 in Step 2.

The control portion 141 judges the sheet feeding timing by comparing the JOB counter X with the sheet feeding ON timing A in Step 3. The control portion 141 increases the JOB counter X by unit time of 0.1 second and repeats the judgment until when the JOB counter X reaches the sheet feeding ON timing A (Steps 3 and 4). Although the control portion 141 judges the sheet feeding ON timing A per 0.1 second here, the control portion 141 may be arranged so as to judge more finely depending on performance of the control portion 141.

When the JOB counter X becomes equal to the sheet feeding ON timing A (X=A), the control portion 141 actuates the registration roller 12 to execute the sheet feeding operation in Step 5.

Then, the control portion 141 judges the pressurizing timing by comparing the JOB counter X with the pressurizing ON timing B in Step 6. That is, the control portion 141 increases the JOB counter X by the unit time of 0.1 second and repeats the judgment until when the JOB counter X reaches the pressurizing ON timing B in Steps 6 and 7.

When the JOB counter X becomes equal to the pressurizing ON timing B (X=B), i.e., Yes in Step 6, the control portion 141 actuates the contacting/separating motor 207 to execute the pressurizing operation.

When the job is a consecutive image forming JOB, the control portion 141 repeats the sheet feeding operation by the registration roller 12 at predetermined intervals while keeping the pressurizing state of the heating nip N until receiving JOB end information in Steps 9 and 10. Receiving the JOB end information, i.e., Yes in Step 9, the control portion 141 halts the sheet feeding operation in Step 11. Then, after when the last recording medium P passes through the fixing apparatus 9, the control portion 141 switches the contacting/separating mechanism 50 to the separation state in Step 11.

As shown in FIG. 5, the timing when the recording medium P enters the heating nip N of the fixing apparatus 9 is automatically determined from the sheet feeding ON timing. Because a conveying distance from the separation roller 6 to the heating nip N of the fixing apparatus 9 is 1920 mm for example and conveyance speed is 320 mm/sec. in the image forming apparatus 100 of the first embodiment, every types of the recording media P enter the heating nip N of the fixing apparatus 9 after 6 seconds from the sheet feeding ON timing.

When transitions of actual surface temperatures of the fusing and pressure rollers 51 and 52 were measured when the sheet feeding and pressurizing operations of the first embodiment are executed on the plain sheet, its result turned out, as follows. It is noted that the temperature of the fusing roller 51 was measured by the temperature sensor 205. Still further, even though the pressure roller 52 of the fixing apparatus 9 is not provided with a heating unit such as a lamp heater, a temperature sensor was disposed at the same position with the fusing roller 51 and temperature variation of the fusing roller 51 was also measured.

Then, it was found that because the pressurizing operation of the heating nip N is completed just before (before 0.2 second) the recording medium P enters the fixing apparatus 9 in the case of the plain sheet, the surface temperature of the fusing roller 51 does not drop unnecessarily and can be controlled optimally. The control portion 141 controls the recording medium cassettes 10a and 10b such that the plain sheet arrives at the heating nip N right after when the pressure roller 52 contacts the fusing roller 51 in the heating process of the plain sheet.

The surface temperature of the pressure roller 52 which is separated from the surface of the fusing roller 51 by about 2 mm in the standby state is kept to be about 100° C. by heat radiated from the fusing roller 51. After that, in the process in which the recording medium P is conveyed through the heating nip N, the surface temperature of the pressure roller 52 varies within a range of 95 to 110° C. in balance with heat transferred from the fusing roller 51 and heat radiated to the recording medium P.

Then, it was confirmed that if the surface temperatures of the fusing and pressure rollers 51 and 52 remain as described above, no such slip of the roller during conveyance nor such phenomenon that disturbs an image as described above occur at all while assuring the image fixability even if a wet and low basis weight coated sheet is fed. After that, the transitions of the actual surface temperatures of the fusing and pressure rollers 51 and 52 were measured when the sheet feeding and pressurizing operations of the first embodiment are executed in the same manner on the thin sheet.

As shown in FIGS. 6 and 7, the control portion 141 controls such that a time D2 from the input of the image forming signal to the contact of the pressure rollers 52 with the fusing roller 51 when the recording medium is a thin sheet is shorter than a time D3 from the input of the image forming signal to the contact of the pressure rollers 52 with the fusing roller 51 when the recording medium is a thick sheet (D2<D3). The control portion 141 also controls such that a time C2 from the contact of the pressure roller 52 with the fusing roller 51 to the arrival of the recording medium at the nip when the recording medium is the thin sheet is longer than a time C3 from the contact of the pressure roller 52 with the fusing roller 51 to the arrival of the recording medium at the nip when the recording medium is the thick sheet (C2>C3).

In other words, the control portion 141 controls the contacting/separating mechanism 50 such that the time D from when the image forming signal is input until when the pressure roller (pressurizing member) 52 in the standby state contacts the fusing roller (image heating member) 51 and forms the nip is shorter in a case when the target temperature of the fusing roller 51 is the second target temperature i.e., the target temperature of the thin sheet, than in a case when the target temperature of the fusing roller 51 is the first target temperature i.e., the target temperature of the thick sheet (D2<D3). The control portion 141 also controls the recording medium feeding timing such that the time C from when the pressure roller 52 contacts the fusing roller 51 and forms the nip until when the recording medium arrives at the nip is longer in the case when the target temperature of the fusing roller 51 is the second target temperature than in the case when the target temperature is the first target temperature (C2>C3).

Still further, when the recording medium is the thin sheet, the control portion 141 controls such that the time D2 from the input of the image forming signal to the contact of the pressure roller 52 with the fusing roller 51 is shorter than the time C2 from the contact of the pressure roller 52 with the fusing roller 51 to the arrival of the recording medium to the nip (D2<C2). That is, when the target temperature of the fusing roller 51 is the second target temperature, the control portion 141 controls the recording medium feeding timing and the contacting/separating mechanism 50 such that the time D2 from when the image forming signal is input until when the pressure roller 52 in the standby state contact the fusing roller 51 and forms the nip is shorter than the time C2 from when the pressure roller 52 in the standby state contact the fusing roller 51 and forms the nip until when the recording medium arrives at the nip (D2<C2).

Still further, the control portion 141 controls such that the time D3 from the input of the image forming signal to the contact of the pressure roller 52 with the fusing roller 51 when the recording medium is the thick sheet is longer than the time C3 from the contact of the pressure roller 52 with the fusing roller 51 to the arrival of the recording medium at the nip (D3>C3). That is, when the target temperature of the fusing roller 51 is the first target temperature, the control portion 141 controls the recording medium feeding timing and the contacting/separating mechanism 50 such that the time D3 from when the image forming signal is input until when the pressure rollers 52 in the standby state contacts with the fusing roller 51 and forms the nip is longer than the time C3 from when the pressure rollers 52 contacts with the fusing roller 51 and forms the nip until when the recording medium arrives at the nip (D3>C3).

As shown in Table 2, as compared to the plain sheet, the pressurizing ON timing of the thin sheet is quick even though the their sheet feeding ON timings are the same. In the heating process of the thin sheet, the control portion 141 contacts the pressure roller 52 with the fusing roller 51 in the same time as the temperature control portion 200 switches the target temperature in the standby state to the second target temperature.

As a result, extra heat of the fusing roller 51 is transferred to the pressure roller 52 and the drop of the surface temperature of the fusing roller 51 is accelerated until when the recording medium P arrives at the heating nip N, so that the temperature of the fusing roller 51 reaches the target temperature of 160° C. quickly more than a comparative example 1. The comparative example 1 indicates transition of the surface temperature of the fusing roller 51 when the target temperature is lowered from 180° C. to 160° C. on starting a job and when no recording medium P is fed without contacting the pressure roller 52 with the fusing roller 51. Because the surface temperature of the fusing roller 51 does not drop due to the contact of the pressure roller 52 in the comparative example 1, a downtime close to 20 seconds is required until when the surface temperature of the fusing roller 51 drops to 160° C.

The comparative example 2 indicates transition of the surface temperature of the fusing roller 51 only when the pressurizing operation is executed without executing the sheet feeding operation in the control of the first embodiment. In the comparative example 2, because the recording medium P is not conveyed to the heating nip N at the time when the surface temperature of the fusing roller 51 drops to 160° C., the removal of heat of the fusing roller 51 by the pressure roller 52 still continues, dropping the surface temperature of the fusing roller 51 below 160° C. Even though the temperature control portion 200 actuates the lamp heater 201 after that to control the surface temperature of the fusing roller 51 so as to be 160° C., a downtime close to 20 seconds is required in any way when the recording medium is fed and a feeding time of 6 seconds is added after that.

As compared to the comparative example 2 that cools the fusing roller 51 by simply contacting the pressure roller 52 with the fusing roller 51, the control of the first embodiment shortens a waiting time (downtime) in forming an image after switching the target temperatures. It is possible to suppress temperature variation of the heating nip N during when the recording medium is conveyed by lessening the drop of temperature of the fusing roller 51 by timely inserting the thin sheet whose effect of removing the heat of the fusing roller 51 is smaller than that of the pressure roller 52 through the heating nip N.

According to the control of the first embodiment, the recording medium is sent to and is heated in the heating nip N in a transient state of dropping the temperature of the image heating member from the target temperature of the standby state to the second target temperature. Therefore, a time for waiting for the start of formation of an image is considerably shortened as compared to a case of starting to form an image by waiting for the time when the temperature of the image heating member ends to drop and is stabilized at the second target temperature.

According to the control of the first embodiment, it is possible to downsize the apparatus because the temperature of the image heating member is controlled by using existing contacting/separating mechanism. Still further, even if image forming apparatus is configured to use a cool fan, in addition to the control of the present embodiment, it is possible to downsize the cooling fan and the apparatus.

According to the control of the first embodiment, unevenness of distribution of temperature of the fusing roller 51 hardly occurs in the direction of the rotational axis as compared to the case of cooling by the cooling fan. Then, it is possible to control the fusing roller 51 at the optimal temperature stably without requiring a new waiting time when the recording medium is the thin sheet.

According to the control of the first embodiment, it is possible to execute the optimal sheet feeding operation sequence and the pressurizing operation sequence per type of the recording medium. Thereby, it is possible to control the surface temperature of the fusing roller 51 at the appropriate target temperature corresponding to a selected recording medium P stably without unevenness by the minimum waiting time as the image forming apparatus 100.

FIG. 7 shows the transition of the actual surface temperatures of the fusing and pressure rollers 51 and 52 when the sheet feeding and pressurizing operations of the first embodiment are executed in the same manner also on the thick sheet. As shown in Table 2, the pressurizing ON timing of the thick sheet is set just before when the recording medium P arrives at the heating nip N similarly to the case of the plain sheet in order to reduce the drop of the temperature of the fusing roller 51 caused by the contact with the pressure roller 52. In the heating process of a thick sheet, the control portion 141 controls the recording medium cassettes 10a and 10b such that the plain sheet arrives at the heating nip N right after when the pressure roller 52 contacts with the fusing roller 51.

However, the temperature of the fusing roller 51 cannot reach the desired temperature before an arrival of the sheet to the nip if the sheet feeding operation is started with the same timing with that of the plain sheet, so that the sheet feeding ON timing is delayed by 2 seconds more than that of the plain sheet to assure a time for increasing the temperature of the fusing roller 51. Although the delay time of 2 seconds can be shortened by increasing power of the lamp heater 201, the fixing apparatus 9 is arranged to be able to control the temperature of the fusing roller 51 by a minimum waiting time that satisfies the fixability in the present embodiment.

It is noted that the examples of the control of the control portion 141 when the target temperature of the standby state is 180° C. and the second target temperature is 160° C. have been explained in the first embodiment. However, in a case when a type of recording medium whose second target temperature is still lower and a difference of temperature with the target temperature of the standby state is large, the drop of the temperature of the fusing roller 51 is accelerated by prolonging the time from when the heating nip N is formed till when the recording medium arrives at the heating nip N.

Still further, in the heating process of the thin sheet, the control portion 141 controls the recording medium feeding step such that the thin sheet arrives at the heating nip N before when the temperature of the fusing roller 51 drops from 180° C. to 160° C.° C. and such that the temperature of the fusing roller 51 reaches to the second target temperature in the process when the thin sheet passes through the heating nip N.

This arrangement enables the fusing roller 51 to heat the sheet within a range close to the second target temperature by preventing an overshoot of the drop of the temperature of the heating nip N by utilizing thermal insulating property of the recording medium.

It is noted that the target temperature during the standby state of the image forming job is not limited to be 180° C., i.e., the target temperature of the plain sheet, and it is possible to select arbitrary temperature lower than 200° C., i.e., the target temperature of the thick sheet 2. Still further, the standby target temperature may be any temperature as long as the temperature is less than the first target temperature, and when a first recording medium is a plain sheet and a second recording medium is a thin sheet, this standby target temperature is equalized with the first target temperature.

### Second Embodiment

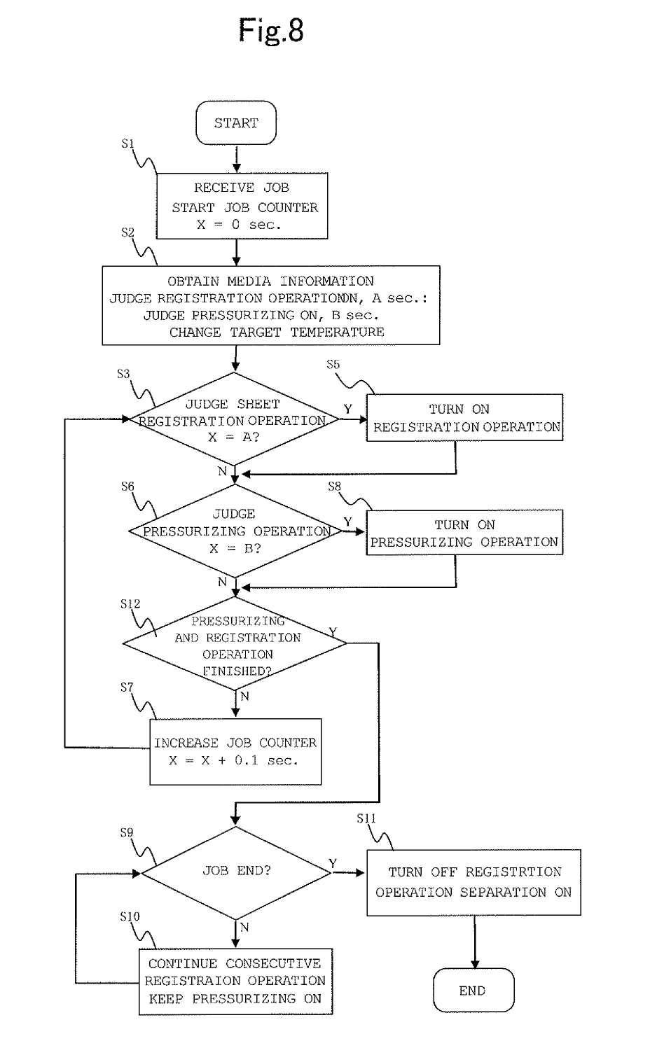

FIG. 8 is a fixing control flowchart of a second embodiment. The sheet feeding and pressurizing operations of the second embodiment are executed in the same timing with that of the first embodiment after starting the image forming job. Therefore, the operations of the image forming apparatus 100, the transmission of the temperatures of the fusing and pressure rollers 51 and 52 shown in FIGS. 5, 6 and 7 and effects of the second embodiment are the same with those of the first embodiment. However, while the sheet feeding operation is controlled by the separation roller in the first embodiment, the control of the sheet feeding operation is executed by the registration roller 12 in the second embodiment. Accordingly, only a difference from the first embodiment will be explained in the following explanation and the configurations in common with those of the first embodiment will be omitted here.

Table 3 shows registration operation ON (sheet feeding) timing and the pressurizing operation ON timing per each type of the recording medium in the second embodiment.

TABLE 3

| TYPE OF | REGISTRATION | PRESSURIZING | HEATING NIP |
|---|---|---|---|
| RECORDING | OPERATION: | OPERATION: | ENTERING |
| MEDIUM | ON [A] | ON [B] | TIMING |
| THIN SHEET | 3 sec. | 1 sec. | (6 sec.) |
| PLAIN SHEET | 3 sec. | 5 sec. | (6 sec.) |
| FIRST | 5 sec. | 7 sec. | (8 sec.) |
| THICK SHEET | | | |
| SECOND | 7 sec. | 9 sec. | (10 sec.) |
| THICK SHEET | | | |

The sheet feeding ON timings of the separating roller 6 in Table 2 are replaced with registration operation ON timings respectively shifted by 3 seconds from the sheet feeding ON timings in Table 3. The registration operation ON timing is timing when the recording medium P is started to be sent out by the registration roller 12.

As shown in FIG. 1, when the image forming job is started, the registration roller 12 temporarily stops the recording medium P regardless of the type of the recording medium after when the separating roller 6 starts the sheet feeding operation. Then, the registration roller 12 is started to be driven again at the registration operation ON timing obtained by making reference to the type of the recording medium in Table 3, the toner image is transferred to the recording medium P and the fixing apparatus 9 is conveyed to the fixing apparatus 9.

By making reference to FIG. 2 and as shown in FIG. 8 in particular, the control portion 141 executes the judgment flow which is basically the same with that of the first embodiment shown in FIG. 4. However, differing from the first embodiment, an order which precedes among the registration operation and the pressurizing operation differs depending on the type of the recording medium P. When the recording medium is the thin sheet for example, the registration operation ON timing A=3 seconds and the pressurizing ON timing B=1 second, so that the pressurizing operation of the heating nip N precedes the registration operation. When the recording medium is the plain sheet, the registration operation ON timing A=3 seconds and the pressurizing ON timing B=5 seconds, so that the registration operation of the registration roller 12 precedes the pressurizing operation. Therefore, the respective operations are judged every time when the judgment is made in the flow of the second embodiment. Then, after judging that the both operations are completed, the control shifts to the judgment of end of JOB in Step 9.

According to the control of the second embodiment, it is possible to execute the recording medium P conveying operation more accurately because the registration roller 12 is closer to the fixing apparatus 9 more than the separating roller 6. Therefore, it is possible to stably control the surface temperature of the fusing roller 51, when the recording medium P arrives at the heating nip N, to be close to the target temperature.

### Third Embodiment

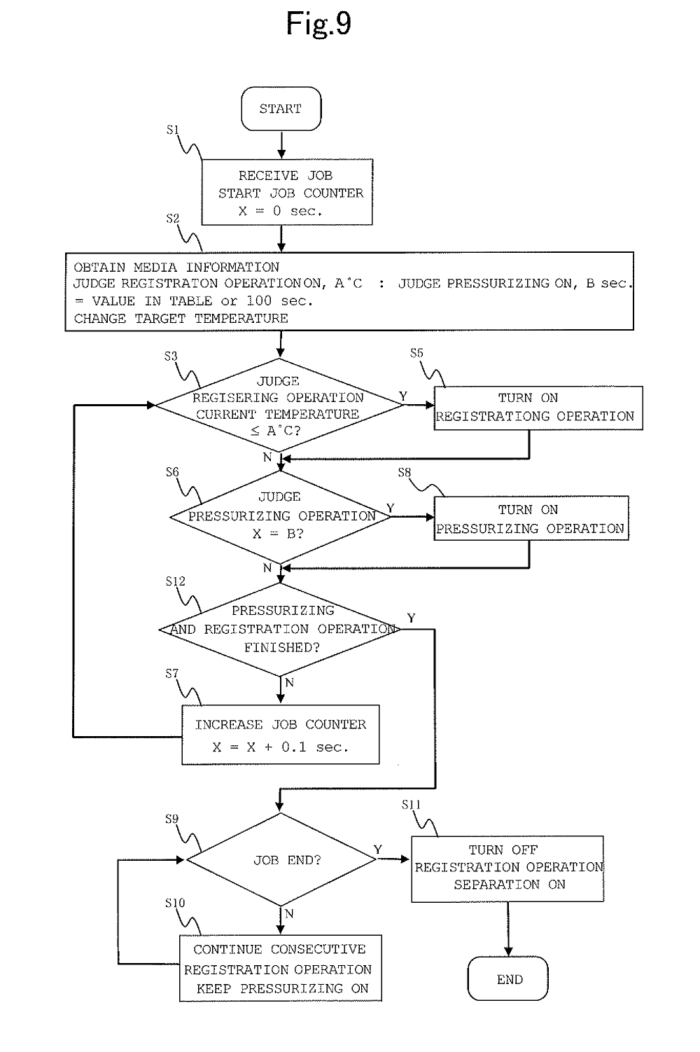

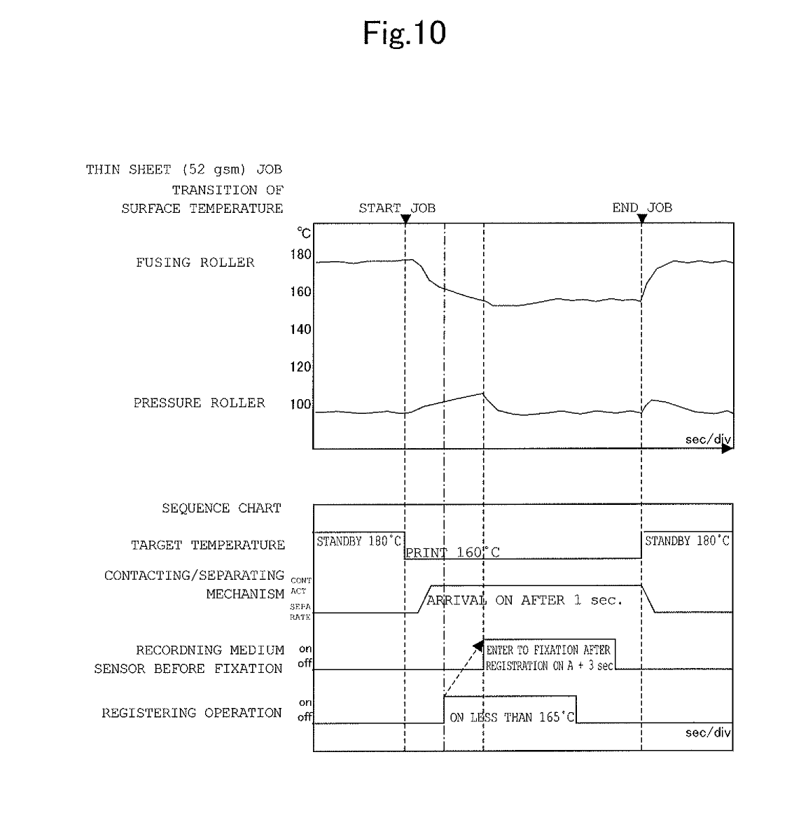

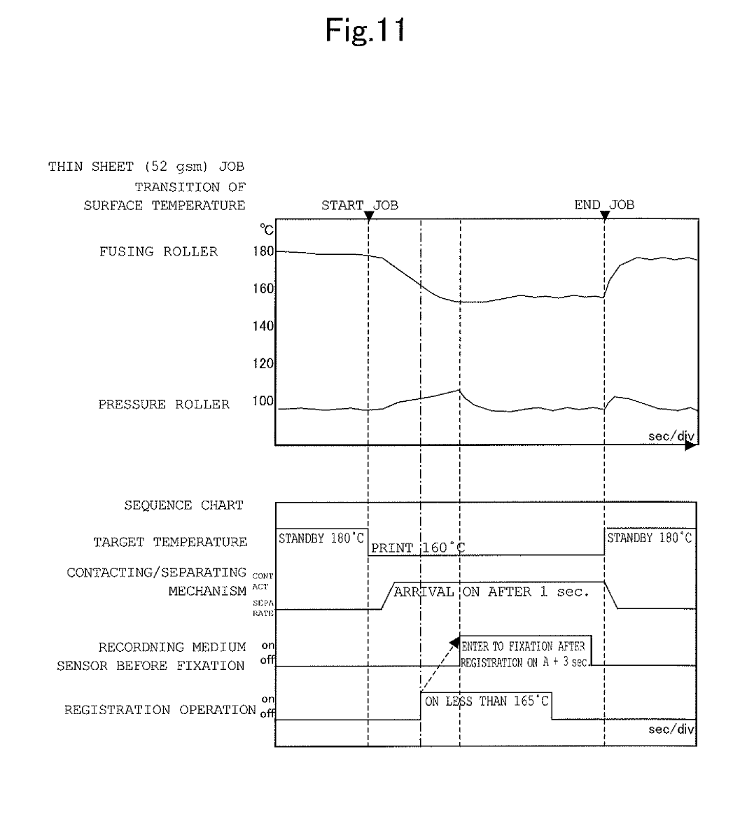

FIG. 9 is a fixing control flowchart of a third embodiment, FIG. 10 is a time chart of the fixing control implemented on the thin sheet, and FIG. 11 is a time chart illustrating effects of the control of the third embodiment. In the third embodiment, the control portion 141 judges the registration operation ON timing in the second embodiment not by making reference to the fixed time table by the JOB counter but by current temperature of the fusing roller 51 detected by the temperature sensor 205. Therefore, only the difference from the second embodiment will be explained in the following description and an explanation of the configurations in common with those of the second embodiment will be omitted here.

As shown in FIG. 2, the control portion 141 starts to convey the recording medium when the temperature sensor 205 reaches to predetermined temperature in the process of drop of the temperature of the fusing roller 51 from the standby state target temperature of 180° C. to the second target temperature of 160° C., and sends out of the registration roller 12. Table 4 shows the registration operation ON (sheet feeding) timing and the pressurizing ON timing per type of the recording medium in the third embodiment.

TABLE 4

| TYPE OF RECORDING | REGISTRATION | PRESSURIZING | HEATING NIP ENTERING |
|---|---|---|---|
| MEDIUM | OPERATION: ON [A] | OPERATION: ON [B] | TIMING |
| THIN SHEET | CURRENT TEMPERATURE < 165° C. | 1 sec. | (REGISTRATION OPERATION: |
| | | | ON + 3 sec.) |
| PLAIN SHEET | CURRENT TEMPERATURE < 175° C. | (REGISTRATION | (REGISTRATION OPERATION: |
| | | OPERATION: ON + 2 sec.) | ON + 3 sec.) |
| FIRST THICK SHEET | CURRENT TEMPERATURE < 185° C. | (REGISTRATION | (REGISTRATION OPERATION: |
| | | OPERATION: ON + 2 sec.) | ON + 3 sec.) |
| SECOND THICK SHEET | CURRENT TEMPERATURE < 195° C. | (REGISTRATION | (REGISTRATION OPERATION: |
| | | OPERATION: ON + 2 sec.) | ON + 3 sec.) |

As shown in Table 4, when the recording medium is the thin sheet, the control portion 141 executes the pressurizing operation of the pressure roller 52 in the same time with the switch of the target temperature of the fusing roller 51 from 180° C. to 160° C. after one second from receiving an image forming job. Thereby, the control portion 141 executes the registration operation of the registration roller 12 (delivery of the recording medium P) when the detected result of the temperature sensor 205 drops from 180° C. to 165° C. or less.

When the recording medium is the plain sheet, the control portion 141 executes the delivery of the recording medium P by the registration roller 12 when the detected result of the temperature sensor 205 is 175° C. or more, the control portion 141 executes the registration operation immediately in the standby state at 180° C. and executes the pressurizing operation of the pressure roller 52 after two seconds from the registration operation. With this arrangement, the recording medium P arrives at the heating nip N right after when the heating nip N is formed. The two seconds is a time required for the recording medium P delivered by the registration roller 12 to be conveyed to the heating nip N.

When the recording medium is the first thick sheet, the control portion 141 switches the target temperature of the fusing roller 51 from 180° C. to 190° C. after one second after receiving the image forming job. After that, the control portion 141 executes the delivery of the recording medium P by the registration roller 12 when the detected result of the temperature sensor 205 rises from 180° C. and exceeds 185° C. In the case of the second thick sheet, the control portion 141 increases the temperature of the fusing roller 51 to 200° C. and executes the delivery of the recording medium P by the registration roller 12 when the detected result of the temperature sensor 205 exceeds 195° C.

With reference to FIG. 2 and as shown in FIG. 9 in particular, the control portion 141 resets the JOB counter X and starts the timer operation after receiving JOB information in Step 1.

The control portion 141 reads information on the type of the recording medium P contained in the JOB information and obtains target temperature to be used, executing temperature A (° C.) of the registration operation, and the pressurizing time B (second) of the heating nip N by making reference to the types of the recording media in Table 4 in Step 2. Then, the control portion 141 switches the target temperature of the fusing roller 51 by commanding to the temperature control portion 200 in Step 2.

As shown in Table 4, when the recording medium is the plain sheet, the first thick sheet or the second thick sheet, the pressurizing timing B (second) is represented not by a fixed value (second) but by a relative value (second) to the registration operation timing, so that an initial value of the value B is set provisionally at 100 seconds. Then, when the registration operation is executed after judging the temperature of the temperature sensor 205 in Step 5, the value B is set again by adding two seconds to the registration operation timing.

The control portion 141 judges the sheet feeding timing by comparing level of the current temperature of the fusing roller 51 detected by the temperature sensor 205 with that of the temperature A of the registration operation ON in Table 4 in Step 3. Then, the control portion 141 repeats the judgment in Steps 3, 6 and 12 by increasing the JOB counter X by 0.1 second in Step 7 until reaching to the temperature A of the registration operation ON, i.e., No in Step 3.

When the current temperature of the fusing roller 51 is equalized with the temperature A, i.e., Yes in Step 3, the control portion 141 actuates the registration roller 12 and executes the sheet feeding operation in Step 5. The pressurizing timing B (second) of the heating nip N is set by adding two seconds to the time at that moment.

The control portion 141 judges the pressurizing timing by comparing the JOB counter X with the pressurizing ON timing in Step 6. The control portion 141 repeats the judgment (Steps 6 and 12) by increasing the JOB counter X by 0.1 second of unit time until reaching to the pressurizing ON timing B, i.e., No in Step 6. Then, when JOB counter X=B, i.e., Yes in Step 6, the control portion 141 actuates the contacting/separating motor 207 to execute the pressurizing operation in Step 8.

When the registration operation and the pressurizing operation end, i.e., Yes in Step 12, the control portion 141 judges whether or not the JOB ends in Step 9. The control portion 141 repeats the sheet feeding operation of the registration roller 12 at predetermined intervals until when it receives information of the end of JOB in Step 10. When the control portion 141 receives the information on the end of JOB, i.e., Yes in Step 9, the control portion 141 halts the sheet feeding operation of the registration roller 12 and switches the contacting/separating mechanism 50 to the separated condition after when the last recording medium P passes through the fixing apparatus 9 in Step 11.

The registration operation is executed in a stage when the temperature of the fusing roller 51 converges to a certain temperature per each recording medium in the control of the third embodiment, so that the temperature of the fusing roller 51 varies less when the same type of recording medium passes through the heating nip N as compared to the first embodiment in which the registration operation is executed with the fixed seconds.

As a result, it is possible to absorb variation of temperature of the core metal 51a of the fusing roller 51 accumulated by hysteresis of the image forming jobs and variation of a temperature drop curve of the fusing roller 51 caused by outside temperature and others of the image forming apparatus 100 for example. Therefore, it is possible to control the temperature of the fusing roller 51 stably more than the first embodiment.

FIGS. 10 and 11 show the effects of the control of the third embodiment confirmed by experiments that the variation of the temperature of the fusing roller 51 is small when the same type of recording medium passes through the heating nip N. That is, FIG. 10 shows transitions of the temperatures of the fusing and pressure rollers 51 and 52 in a first image forming job on the thin sheet after activating the image forming apparatus 100. FIG. 11 shows transitions of the temperatures of the fusing roller 51 and the pressure roller 52 when the image forming job is executed on the same thin sheet with that of FIG. 10 right after repeating five times of consecutive image forming JOBs on 100 plain sheets.

As shown in FIG. 10, differing from the first and second embodiments, the registration operation is executed by making reference to the actual transition of the temperature of the fusing roller 51 in the third embodiment, so that it is possible to control the temperature accurately corresponding to the environment.

As shown in FIG. 11, because the temperature of the core metal 51a of the fusing roller 51 is high when the consecutive image forming jobs of plain sheets are executed immediately before the execution of the image forming job of the thin sheet, the drop of the temperature of the fusing roller 51 is delayed even if the pressurizing operation is executed with the same timing with FIG. 10. That is, the arrival to 165° C. where the registration operation is ON is delayed by about one second as compared to FIG. 10.

However, it is possible to constantly reproduce the temperature of the fusing roller 51 when the recording medium P actually passes through the heating nip N by judging the registration operation timing not by the fixed elapsed time from the start of the JOB but by the detected result of the temperature sensor 205. With this arrangement, it is possible to eliminate differences of glossiness of fixed images or of fixing qualities. The optimal sequence that is not affected by the ambient environment of the image forming apparatus 100 or the just previous state of use enables to control the temperature of the fusing roller 51 more stably than the first and second embodiments. It is thus possible to control the surface temperature of the fusing roller 51 stably in a shortest possible waiting time in the state of use of the image forming apparatus by implementing the optimal recording medium feeding operations and the pressurizing operation of the heating nip corresponding to the type of the recording medium.

### Fourth Embodiment

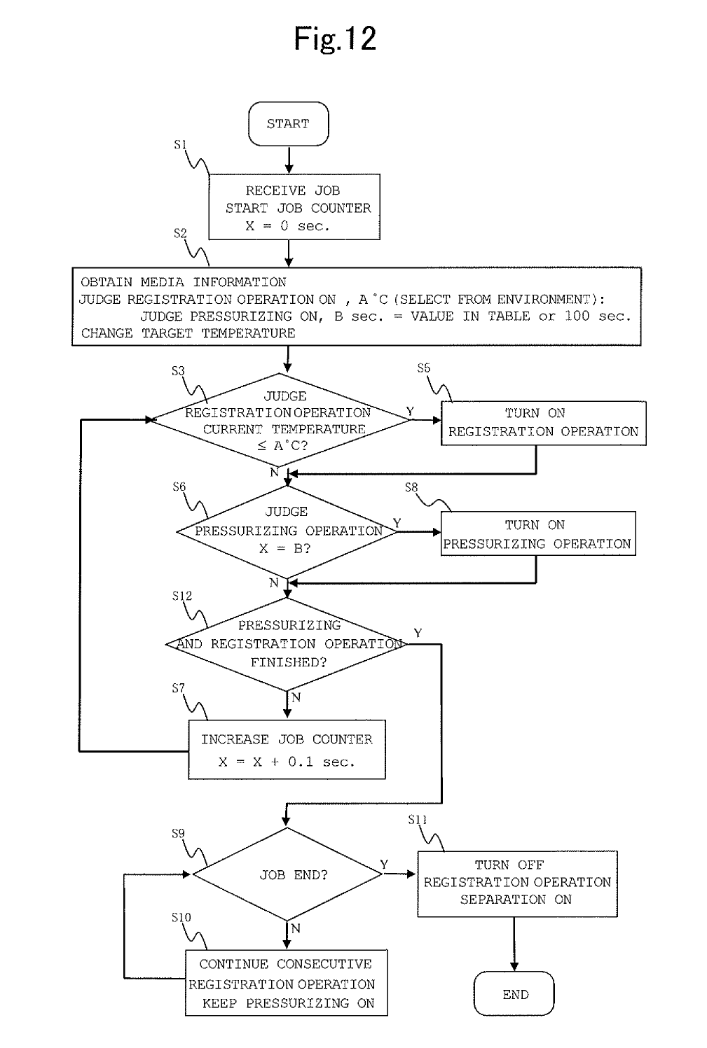

FIG. 12 is a fixing control flowchart of a fourth embodiment. The fourth embodiment is the same with the third embodiment except that the temperature for judging the registration operation ON is replaced with temperature and humidity within the image forming apparatus 100. Therefore, steps in FIG. 12 in common with those in the third embodiment will be denoted by the same reference numerals in FIG. 9 and an overlapped explanation thereof will be omitted here. FIG. 12 is different from FIG. 9 only in a part of Step 2. An explanation of the other configurations in common with those of the third embodiment will be also omitted here.

As shown in FIG. 1, the temperature and humidity sensor 208, i.e., one exemplary humidity sensor, detects humidity within the image forming apparatus 100. The control portion 141 sets the temperature such that the higher the absolute humidity, the lower the temperature is in starting to convey the recording medium in the fourth embodiment. The temperature and humidity sensor 208 is attached at a location close to the recording medium cassette 10 within the image forming apparatus 100 to detect humidity and moisture of the recording medium P on which an image is formed. That is, the temperature and humidity sensor 208 detects the temperature and humidity of a storing portion of the recording medium on which an image is formed.

The control portion 141 changes the temperature for judging the registration operation ON by temperature information detected by the temperature and humidity sensor 208 and by absolute humidity (humidity g contained in 1 kg of air) calculated from the temperature information and relative humidity information. The control portion 141 controls such that the higher the absolute humidity based on an output of the temperature and humidity sensor 208, the lower the predetermined temperature for sending out the recording medium is. Table 5 shows the sheet feeding ON timing and pressurizing ON timing per type of the recording medium in the fourth embodiment.

TABLE 5

| TYPE | | | |
|---|---|---|---|
| OF RECORDING | | PRESSURIZING | HEATING NIP ENTERING |
| MEDIUM | REGISTRATION OPERATION: ON [A] | OPERATION: ON [B] | TIMING |
| THIN SHEET | MOISTURE, 10 g/kg OR MORE: CURRENT | 1 sec. | (REGISTRATION OPERATION: ON + |
| | TEMPERATURE < 165° C. | | 3 sec.) |
| | MOISTURE LESS, THAN 10 g/kg: CURRENT | | |
| | TEMPERATURE < 170° C. | | |
| PLAIN SHEET | OUTSIDE TEMPERATURE, LESS THAN 15° C.: | (REGISTRATION OPERATION: | (REGISTRATION OPERATION: ON + |
| | CURRENT TEMPERATURE < 175° C. | ON + 2 sec.) | 3 sec.) |
| | OUTSIDE TEMPERATURE, 15° C. OR MORE: | | |
| | CURRENT TEMPERATURE < 170° C. | | |
| FIRST THICK | OUTSIDE TEMPERATURE, LESS THAN 15° C.: | (REGISTRATION OPERATION: | (REGISTRATION OPERATION: ON + |
| SHEET | CURRENT TEMPERATURE < 185° C. | ON + 2 sec.) | 3 sec.) |
| | OUTSIDE TEMPERATURE, 15° C. OR MORE: | | |
| | CURRENT TEMPERATURE < 180° C. | | |
| SECOND THICK | OUTSIDE TEMPERATURE, LESS THAN 15° C.: | (REGISTRATION OPERATION: | (REGISTRATION OPERATION: ON + |
| SHEET | CURRENT TEMPERATURE < 195° C. | ON + 2 sec.) | 3 sec.) |
| | OUTSIDE TEMPERATURE, 15° C. OR MORE: | | |
| | CURRENT TEMPERATURE < 190° C. | | |

As shown in Table 5, the temperature [A] for judging the registration operation ON of Table 4 is selected in two stages from the detected result of the temperature and humidity sensor 208. The selection is made to shorten a recording medium feeding waiting time in the consolidated job. In other words, the switching of JOB is implemented in a necessary shortest possible waiting time to improve the productivity of the consolidated job.

A range of the temperature of the fusing roller 51 that satisfies the fixability in the case of the thick sheet 2 is different depending on temperature of the recording medium P in the recording medium cassette 10. The temperature for judging the registration operation in the case of the thick sheet 2 is bounded by environmental temperature of 15° C. Because the fixability is worsened when the temperature of the recording medium P is lower than 15° C., the control portion 141 starts to feed the sheet after fully increasing the temperature of the fusing roller 51 to 195° C. or more in switching to the thick sheet 2 in the consolidated job of the thick sheet 2 and the thin sheet.

A range of the temperature of the fusing roller 51 that satisfies the separability of the thin sheet differs depending on the moisture of the recording medium P in the recording medium cassette 10. The temperature for judging the registration operation in the case of the thin sheet is bounded by 10 g/kg (correspond to 27 cc/70% RH) of humidity. The separability from the fusing roller 51 is worsened if the moisture of the recording medium P is 10 g/kg or more, so that the control portion 141 starts to feed the sheet after fully lowering the temperature of the fusing roller 51 in switching to the thin sheet in the consolidated job of the thick sheet 2 and the thin sheet.

A secondary object of the fourth embodiment is to improve a life of the fixing apparatus 9. Shortening of the recording medium feeding waiting time leads to shortening of an operation time of the fixing apparatus 9 per number of formed images and then to shortening of driving time of the fusing roller 51, the pressure roller 52 and the related sliding members. Thus, the improvement of the productivity of the consolidated job leads to the improvement of the durability and the life of the fixing apparatus 9 by reducing frequency of replacing parts of the fixing apparatus 9.

By making reference to FIG. 2 and as shown in FIG. 12 in particular, the control portion 141 obtains the temperature [A]° C. for judging the registration operation selectively from Table 5 based on the output information of the temperature and humidity sensor 208 in Step 3.

When the consolidated job of the thin sheet and the thick sheet 2 is executed by changing the environment by the image forming apparatus 100 carrying the fixing control system of the fourth embodiment, an effect of shortening the feed waiting time of 20 seconds in maximum is obtained in switching the types of the recording media as a result. The consolidated job can be executed without damaging the separability of the thin sheet and the fixability of the thick sheet 2 and without causing any problems in the basic function such as output image quality. Thus, the compativility of the improvement of the productivity and the basic function of the consolidated job can be demonstrated by optimizing the control of the temperature of the fusing roller 51 corresponding to the environmental conditions. It is also possible to improve the productivity of the consolidated job and the durability and the life of the fusing roller 51 while keeping the basic functions by changing the sequence corresponding to the environment detected information. It is noted the larger the number of prints of the image forming job, the greater the effect of shortening a time taking to finish the image forming job is, and the shortening effect varies depending on the type of the recording medium P and on the experimental and environmental conditions.

### Fifth Embodiment

The roller-type fixing apparatus in which the both image heating member and pressurizing member are rollers has been explained in the first through fourth embodiments. In contrary to that, a belt-type fixing apparatus in which a fixing nip is formed by an endless belt and a roller disposed inside of the belt as either or both of the image heating member and pressurizing member in a fifth embodiment.

While the tandem-type intermediate transferring color printer in which the image forming portions are arrayed along the intermediate transfer belt has been illustrated in the first through fourth embodiment, the image forming apparatus is not limited to that. That is, the image forming apparatus may be a one drum-type intermediate transferring color printer in which the respective color toner images are formed sequentially on one image carrier and are transferred to an intermediate transfer member or a tandem-type direct transferring color printer which has no intermediate transfer member and in which the respective color toner images are transferred directly from an image carrier to a recording medium. Still further, the image forming apparatus may be other image forming apparatuses such as a copier and facsimile other than a printer.

No lamp heater is provided for the pressure roller 52 and the surface temperature of the pressure roller 52 is not also controlled in the first through fourth embodiments described above. However, it is possible to provide a lamp heater or the like for the pressure roller 52 and to control the surface temperature of the pressure roller 52 at constant temperature lower than that of the fusing roller 51 by about 50° C. That is, the temperature of the pressure roller 52 as the pressurizing member at least needs to be lower than the temperature of the fusing roller 51 when the pressure roller 52 contacts the fusing roller 51 as the image heating member from the standby state and forms the nip in the embodiments described above. To that end, even if a heater for heating the pressurizing member is provided, the standby target temperature of the pressurizing member is set to be lower than the standby target temperature of the image heating member as well.

The fixing apparatus of the embodiments described above may be carried out by other modes in which part or whole of the configuration of the embodiments are replaced with their substitutional configuration as long as the temperature of the image heating member is controlled by adjusting the timing for contacting the pressurizing member with the image heating member.

Accordingly, the image heating member and the pressurizing member may be belt members or roller members as long as the image forming apparatus is configured to be able to contact/separate the image heating member with/from the pressurizing member. The heating system of the image heating member (system of the heater) is not limited to be the lamp heater, and may be any heating system such as an inductive heating, resistive heating, radiation heating and heat pipe system. The invention can be carried out in any type of image forming apparatus such as a charging type, exposure type, developing type, tandem type or one drum type, intermediate transfer type, recording medium conveying type or sheet conveying type image forming apparatuses. Although the only main parts related to the formation and transfer of the toner images have been explained in the embodiments described above, the invention may be carried out in various uses such printers, various printing machines, copiers, facsimile machines and multifunction printers. Still further, the contacting/separating mechanism needs not be the mechanism using the cam as described above, and may be any mechanism such as one that directly moves up and down the pressure roller by using a linear actuator. Furthermore, although the control unit 144 includes the control portion 141 and the temperature control portion 200 in the embodiments described above, the control unit may be composed of one control portion or of a polarity of control portions.

While the embodiments of the invention have been explained above, the invention is not limited to the embodiments described above. Still further, the effects described in the embodiments of the invention are merely the most suitable effects brought about by the invention and the effects of the invention are not limited by those described in the embodiments of the invention.

Aspects of the present invention can also be realized by a computer (such as a CPU or MPU) of a system or apparatus that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device, e.g., computer-readable medium. In an example, a computer-readable storage medium may store a program that causes a sheet storage apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-264057, filed Dec. 1, 2011, which is hereby incorporated by reference herein in its entirety.

What is claimed is:

1. An image forming apparatus, comprising:
an image heating member configured to heat an image formed on a recording medium;
a heater configured to heat the image heating member;
a pressurizing member configured to pressurize the image heating member to form a nip for nipping and conveying the recording medium;
a contacting/separating mechanism configured to contact the pressurizing member with the image heating member and to separate the pressurizing member from the image heating member; and
a control unit configured to control the heater such that a temperature of the image heating member is set at a target temperature and being able to switch, on starting to heat the image formed on the recording medium, the target temperature at least from a standby target temperature which is the target temperature during a standby state in which the pressurizing member is separated from the image heating member to a first target temperature which is the target temperature in heating an image formed on a first recording medium or to a second target temperature which is the target temperature in heating an image formed on a second recording medium whose basis weight is smaller than a basis weight of the first recording medium and which is lower than the standby target temperature and the first target temperature, the control unit controlling the contacting/separating mechanism such that a time from when an image forming signal is input until when the pressurizing member in the standby state contacts the image heating member and forms the nip is shorter in a case when the target temperature of the image heating member is the second target temperature than in a case when the target temperature of the image heating member is the first target temperature.

2. The image forming apparatus according to claim 1, wherein the control unit controls a recording medium feeding time such that a time from when the pressurizing member contacts the image heating member and forms the nip until when the recording medium arrives at the nip is longer in the case when the target temperature of the image heating member is the second target temperature than in the case when the target temperature is the first target temperature.

3. The image forming apparatus according to claim 2, wherein the control unit controls the recording medium feeding time and the contacting/separating mechanism in the case when the target temperature of the image heating member is the second target temperature such that the time from when the image forming signal is input until when the pressurizing member in the standby state contacts the image heating member and forms the nip is shorter than the time from when the pressurizing member contacts the image heating member and forms the nip until when the recording medium arrives at the nip.

4. The image forming apparatus according to claim 2, wherein the control unit controls the recording medium feeding time and the contacting/separating mechanism such that the time from when the image forming signal is input until when the pressurizing member in the standby state contacts the image heating member and forms the nip is longer than the time from when the pressurizing member contacts the image heating member and forms the nip until when the recording medium arrives at the nip in the case when the target temperature of the image heating member is the first target temperature.

5. The image forming apparatus according to claim 1, wherein the control unit controls the contacting/separating mechanism in response to the input of the image forming signal such that the pressurizing member starts to contact the image heating member after switching the target temperature of the image heating member.

6. The image forming apparatus according to claim 1, wherein the standby target temperature is a temperature less than the first target temperature.

7. The image forming apparatus according to claim 1, further comprising a thermometer configured to detect the temperature of the image heating member;
wherein when the target temperature of the image heating member is the second target temperature, the control unit controls recording medium feeding timing to start to convey the recording medium when the thermometer detects that the temperature of the image heating member reaches a predetermined temperature in a process in which the temperature of the thermometer drops from the standby target temperature to the second target temperature.

8. The image forming apparatus according to claim 7, further comprising a humidity sensor configured to detect humidity within the image forming apparatus;
wherein the control unit sets the predetermined temperature to be low as the absolute humidity increases.

9. The image forming apparatus according to claim 1, further comprising a pressurizing member heater configured to heat the pressurizing member;
wherein the control unit sets a standby target temperature of the pressurizing member to be lower than the standby target temperature of the image heating member.

10. An image forming apparatus, comprising:
an image heating member configured to heat an image formed on a recording medium;
a pressurizing member configured to pressurize the image heating member to form a nip for nipping and conveying the recording medium;
a contacting/separating mechanism configured to contact the pressurizing member with the image heating member and to separate the pressurizing member from the image heating member; and
a control unit configured to control power such that a temperature of the image heating member reaches a target temperature set in advance;
wherein the control unit discriminates a type of the recording medium,
wherein the control unit is able to execute a first mode of heating an image formed on a first recording medium by controlling power such that the target temperature reaches a first target temperature and a second mode of heating an image formed on a second recording medium having less basis weight than a basis weight of the first recording medium by controlling power such that the target temperature reaches a second target temperature which is lower than the first target temperature,
wherein the control unit is able to execute a standby mode of standing by an input of an image forming signal by controlling power such that the temperature of the image heating member reaches a target temperature higher than the second target temperature in a state in which the pressurizing member is separated from the image heating member, and
wherein the control unit controls such that a time from the input of the image forming signal to a contact of the pressurizing member with the image heating member in the second mode is shorter than a time from the input of the image forming signal to the contact of the pressurizing member with the image heating member in the first mode.

11. The image forming apparatus according to claim 10, wherein the control unit controls such that a time from the contact of the pressurizing member with the image heating member to the arrival of the recording medium to the nip in the second mode is longer than a time from the contact of the pressurizing member with the image heating member to the arrival of the recording medium to the nip in the first mode.

12. The image forming apparatus according to claim 11, wherein the control unit controls such that, in the second mode, the time from the input of the image forming signal to the contact of the pressurizing member with the image heating member is shorter than the time from the contact of the pressurizing member with the image heating member to the arrival of the recording medium to the nip.

13. The image forming apparatus according to claim 11, wherein the control unit controls such that, in the first mode, the time from the input of the image forming signal to the contact of the pressurizing member with the image heating member is longer than the time from the contact of the pressurizing member with the image heating member to the arrival of the recording medium to the nip.

14. An image forming apparatus, comprising:
an image heating member configured to heat an image formed on a recording medium;
a pressurizing member configured to pressurize the image heating member to form a nip for nipping and conveying the recording medium;
a contacting/separating mechanism configured to contact the pressurizing member with the image heating member and to separate the pressurizing member from the image heating member; and
a control unit configured to control power such that a temperature of the image heating member reaches a target temperature set in advance;
wherein the control unit discriminates a type of the recording medium,
wherein the control unit is able to execute a first mode of heating an image formed on a first recording medium by controlling power such that the target temperature reaches a first target temperature and a second mode of heating an image formed on a second recording medium having less basis weight than a basis weight of the first recording medium by controlling power such that the target temperature reaches a second target temperature which is lower than the first target temperature,
wherein the control unit is able to execute a standby mode of standing by an input of an image forming signal by controlling power such that the temperature of the image heating member reaches a target temperature higher than the second target temperature in a state in which the pressurizing member is separated from the image heating member, and
wherein the control unit controls such that a time from the contact of the pressurizing member with the image heating member to the arrival of the recording medium to the nip in the second mode is longer than a time from the contact of the pressurizing member with the image heating member to the arrival of the recording medium to the nip in the first mode.
